(19) United States
(12) Patent Application Publication
(10) Pub. No.: US 2021/0309017 A1
(43) Pub. Date: Oct. 7, 2021

(54) PRINT FLUID DELIVERY WITH MULTIPLE TANKS

(71) Applicant: Hewlett-Packard Development Company, L.P., Spring, TX (US)

(72) Inventors: William Scott Osborne, Corvallis, OR (US); David D. Welter, Corvallis, OR (US); John James Cantrell, Vancouver, WA (US); Keith William Jariabka, Vancouver, WA (US)

(73) Assignee: Hewlett-Packard Development Company, L.P., Spring, TX (US)

(21) Appl. No.: 17/260,076

(22) PCT Filed: Nov. 20, 2018
(86) PCT No.: PCT/US2018/062098

§ 371 Date: Jan. 13, 2021

(51) Int. Cl. B41J 2/175

(52) U.S. Cl. CPC B41J 2/17556; B41J 2/17566; B41J 2/17526

(57) ABSTRACT

An example of an apparatus is provided. The apparatus includes a main tank disposed above a nozzle. The main tank is to store a bulk amount of print fluid. The apparatus includes a feeder tank in fluidic communication with the main tank and the nozzle. The feeder tank is disposed below the nozzle to maintain a backpressure. The apparatus includes a vent port disposed on the feeder tank. The apparatus includes an exchange port connecting the main tank to the feeder tank. The exchange port allows print fluid to flow from the main tank to the feeder tank in response to a decrease in an amount of print fluid in the feeder tank relative to a threshold amount.

### BACKGROUND

Printing devices are often used to present information. In particular, printing devices may be used to generate output that may be easily handled and viewed or read by users. Accordingly, the generation of output from printing devices from electronic form continue to be used for the presentation and handling of information. The generation of output may involve depositing a print fluid onto a form of media. Accordingly, print fluid is to be delivered to the media from a storage tank. In some cases, such as 3D printing, print fluid may be used to generate output without depositing print fluid on media.

### BRIEF DESCRIPTION OF THE DRAWINGS

Reference will now be made, by way of example only, to the accompanying drawings in which:

FIG. 1 is a schematic representation of an example apparatus to deliver print fluid to a nozzle of a print head assembly;

FIG. 2 is a schematic representation the apparatus shown in FIG. 1 in a different state;

FIG. 3 is a schematic representation of another example apparatus to deliver print fluid to a nozzle of a print head assembly with a refill port;

FIG. 4 is a schematic representation of another example apparatus to deliver print fluid to a nozzle of a print head assembly without a main tank;

FIG. 5 is a schematic representation of another example apparatus to deliver print fluid to a nozzle of a print head assembly with sensors to detect fluid levels;

FIG. 6 is a schematic representation of another example apparatus to deliver print fluid to a nozzle of a print head assembly with a window to observe fluid levels; and

FIG. 7 is a flowchart of an example of a method of delivering print fluid to a nozzle of a print head assembly.

### DETAILED DESCRIPTION

As used herein, any usage of terms that suggest an absolute orientation (e.g. “top”, “bottom”, “vertical”, “horizontal”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

Some printing devices use print fluids to generate output. In such printing devices, fluid delivery systems are generally used to deliver a liquid from one part of the printing device, such as a storage tank to a print head assembly where output is generated. The storage tanks are generally used to store print fluid such that the print head assembly may be able to receive fluid upon demand for the generation of output. Since the print fluid is used to generate the output, the print fluid is to be stored in a storage tank to provide for continuous operation of the printing device, such as the generation of output from the printing device.

Accordingly, for printing devices which may be used to generate a large amount of documents, print fluid may be stored in a storage tank and supplied to a print head assembly. This allows for continued operation of the printing device over longer periods of time. During operation, the print fluid may be deposited onto the media via a nozzle on the print head assembly. To provide ease of access, such as for replacement or refilling of the print fluid in the storage tank, the storage tank may be placed in an elevated position near the top of the printing device.

Since the storage tank is above the print head assembly, gravity will apply a force to the print fluid within the storage tank. This may result in drool from the nozzle between applications of print fluid to the media. Accordingly, the drool may result in unintended application of print fluid to the media. In other cases, the drool from the nozzle may result in a mess within the printing device, such as leaking out of the printing device. The drool may be handled by removing the drool and disposing of the leaking print fluid; however this will result in the wastage of a certain amount of print fluid.

To reduce the likelihood of print fluid drool from the nozzle, an additional tank may be added to the print fluid delivery system. In particular, the additional tank is to be designed at a lower position than the print head assembly such that gravity will pull the print fluid away from the nozzle. Furthermore, since the additional tank is positioned below the print head assembly, a backpressure will be generated at the nozzle to reduce the likelihood of drool. The flow of the print fluid from the storage tank to the additional tank is to be controlled such that the weight of the print fluid in the larger tank does not apply pressure on the print fluid at the nozzle. In particular, the flow control is to be carried out without the use of complicated valves and other components which may fail as well as be generally costly to manufacture and implement.

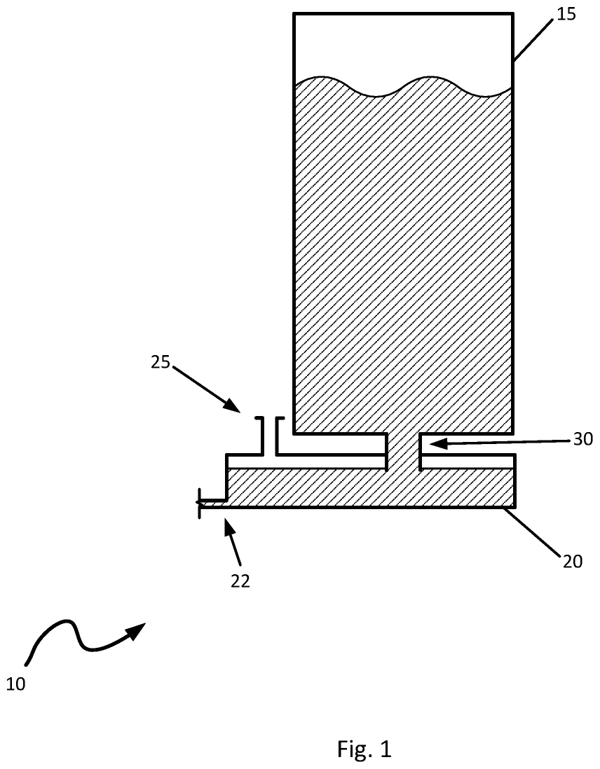

Referring to FIG. 1, an apparatus to deliver print fluid to a nozzle of a print head assembly is generally shown at 10. The apparatus 10 may be a part of the printing device or a separate component to operate on the printing device to deliver print fluid to the printing device. In another example, the apparatus 10 may be a separate and consumable part pre-loaded with print fluid to be used with the printing device. In this example, the apparatus 10 may be disposed of after being depleted. The apparatus 10 may include additional components, such as various additional interfaces and/or connectors to mate with existing connections on the printing device. In the specific example, the apparatus 10 is to provide print fluid to a print head assembly of the printing device while maintaining a negative back pressure from gravity. In the present example, the apparatus 10 includes a main tank 15, a feeder tank 20, a vent port 25, and an exchange port 30.

The main tank 15 is to store a bulk amount of print fluid. In the present example, the main tank 15 includes a housing having walls to define a cavity. The cavity is not limited and may be any shape designed to store the print fluid during operation of the printing device. For example, the main tank 15 may have a unique shape to complement a design of the printing device. The main tank 15 may include a port to receive print fluid from an external source such as a bottle in some examples or a larger external tank via tubing during a filling process. In the present example, the main tank 15 has a capacity of about 70 to about 170 cubic centimeters. However, in other examples, the main tank 15 may have a larger or smaller capacity depending on the design and intended purpose of the printing device. In other examples, the main tank 15 may be substantially cylindrical or rectangular in shape.

The position of the main tank 15 in the printing device is not particularly limited. In the present example, the main tank 15 is positioned at a relatively high position on the printing device as discussed in greater detail below. In particular, the main tank 15 may be positioned above a nozzle of a print head assembly to which the main tank 15 is to supply the print fluid. Accordingly, the main tank 15 is to be easily accessible to a user or an administrator of the printing device for servicing, such as refilling the main tank 15 when empty.

It is to be appreciated that in some examples, the main tank 15 may be a separate component and not be part of the apparatus 10. For example, the main tank 15 may be a consumable part connectable to the exchange port 30 such that the main tank 15 is to be replaced when empty similar to a disposable ink cartridge. In examples where the main tank 15 is a separate consumable part, it is to be appreciated that the user experience may be simplified because the replacement of the entire part is simpler than refilling the main tank 15.

The feeder tank 20 is in fluidic communication with the main tank 15 and the nozzle of the print head assembly of the printing device. In the present example, the feeder tank 20 includes an outlet port 22 leading to the print head assembly. Furthermore, the feeder tank 20 is to be disposed within the printing device below the nozzle at a relatively lower position.

In the present example, the feeder tank 20 further includes a vent port 25 disposed thereon. The vent port 25 vents the feeder tank 20 to atmospheric pressure. In the present example, the vent port 25 may be a simple opening. In other examples, the vent port 25 may include a filter to prevent contaminants from entering the feeder tank 20. In further examples, the vent port 25 may also include valve or other mechanism to prevent print fluid from escaping via the vent port 25 such as when the apparatus 10 is tipped.

It is to be appreciated by a person of skill with the benefit of this description that by positioning the feeder tank 20 below the nozzle and by venting the surface of the print fluid in the feeder tank 20 to atmospheric pressure, a natural backpressure is maintained at the nozzle. Accordingly, the backpressure will reduce drool at the nozzle by applying a force on the print fluid in the line between the outlet port of the feeder tank and the nozzle of the print head assembly.

The exchange port 30 is to connect the main tank 15 to the feeder tank 20 and to control the flow of the print fluid from the main tank 15 to the feeder tank 20. In particular, the exchange port 30 is to limit the flow of print fluid such that print fluid does not flow from the main tank 15 into the feeder tank 20 unless the level of print fluid within the feeder tank 20 decreases below a threshold amount, such as about 5 cubic centimeters. It is to be appreciated that the threshold amount is not limited and that more or less print fluid may be maintained in the feeder tank 20. In the present example, the threshold amount represents a physical level within the feeder tank 20, such as a vertical height of about 5 millimeters above the bottom of the feeder tank 20. Therefore, the feeder tank 20 is to maintain a volume of air (referred to as the feeder tank air) that is to be equilibrated with atmospheric pressure via the vent port 25. The volume of the air in the feeder tank 20 is not limited and may be substantially the same as the amount of print fluid maintained at the threshold amount to improve robustness. However, it is to be appreciated that the amounts need not be maintained at such levels in other examples. It is to be appreciated by a person of skill with the benefit of this description that without controlling the flow of the print fluid from the main tank 15 to the feeder tank 20, the weight of the print fluid in the main tank 15 will push the print fluid out the vent port 25 of the feeder tank 20.

The exchange port 30 controls the flow of print fluid from the main tank 15 into the feeder tank 20 by using the sealed characteristic of the main tank during operation. In the present example, the exchange port 30 is to exchange print fluid with air between the main tank 15 and the feeder tank 20. In one example, the exchange port 30 may be a rigid conduit extending from the main tank 15 into the feeder tank 20. As illustrated in FIG. 1, when the level of print fluid in the feeder tank 20 reaches the bottom of the exchange port 30, a seal is created such that air cannot enter the main tank 15 via the exchange port 30. Accordingly, since the main tank 15 is sealed, the print fluid cannot leave the main tank 15 without any air to displace the print fluid to leave the main tank 15. In other words, the atmospheric pressure of the feeder tank air on the surface of the print fluid within the feeder tank 20 will balance with the weight of fluid in the main tank 15.

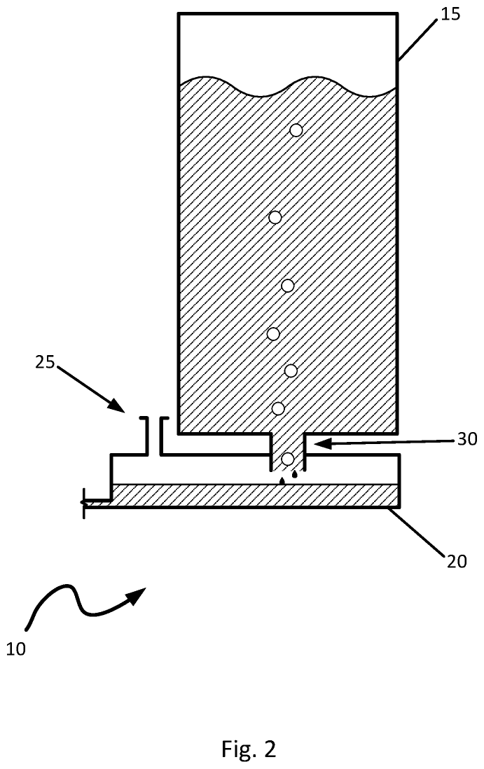

As the print fluid leaves the feeder tank 20 via the outlet port 22 to the print head assembly, the level of print fluid in the feeder tank 20 may decrease and eventually leave a gap between the bottom of the exchange port 30 and the surface of the print fluid in the feeder tank 20. Referring to FIG. 2, as the surface of the print fluid drop below the bottom of the exchange port 30, air may enter the exchange port 30 and up into the main tank 15 to displace some fluid. Accordingly, as air enters that main tank 15, print fluid will flow into the feeder tank 20 due to the air displacing the volume of print fluid. As the print fluid enters the feeder tank 20, the level of the print fluid will rise until it reaches the bottom of the exchange port 30 such that no more air may enter the main tank 15. Accordingly, when the level of the print fluid rises to this height, the conditions shown in FIG. 1 is reached and the flow of liquid from the main tank 15 to the feeder tank 20 is stopped again until the level drops below the bottom of the exchange port 30 again. Therefore, it is to be recognized by a person of skill that the threshold amount at which the print fluid in the feeder tank 20 is maintained is substantially the vertical height between the bottom of the feeder tank 20 and the bottom of the exchange port 30.

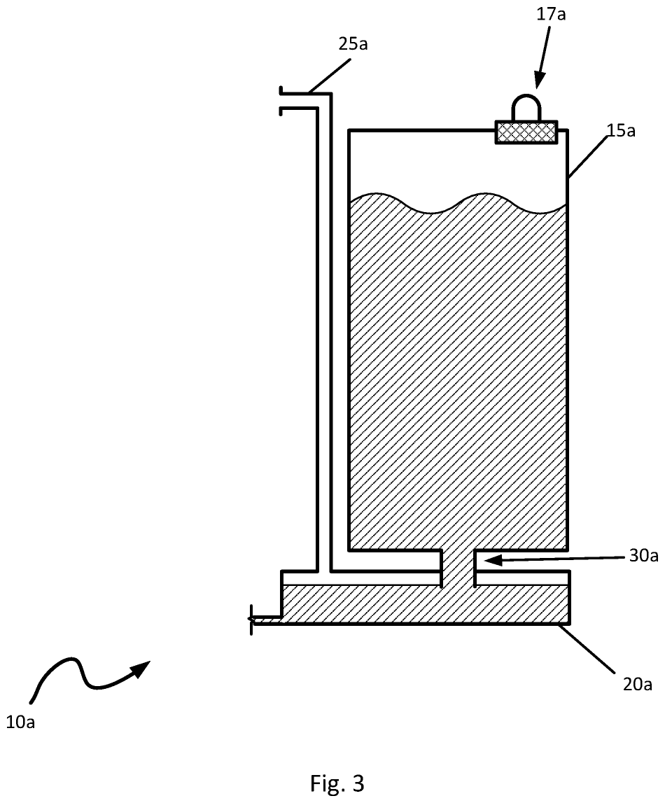

Referring to FIG. 3, an example of an apparatus to deliver print fluid to a nozzle of a print head assembly is generally shown at 10a. Like components of the apparatus 10a bear like reference to their counterparts in the apparatus 10, except followed by the suffix “a”. The apparatus 10a may be a part of a printing device or a sub-component of the printing device to deliver print fluid from a tank to the media. The apparatus 10a includes a main tank 15a, a feeder tank 20a, a vent port 25a, and an exchange port 30a.

The main tank 15a is to store a bulk amount of print fluid. In the present example, the main tank 15a includes a housing having walls to define a cavity and may be similar to the main tank 15 described in the previous example. In the present example, the main tank 15a includes a refill port 17a to refill the main tank 15a. The refill port 17a is not particularly limited and is generally to interface with a print fluid supply, such as a bottle of print fluid having a complementary interface. For example, the refill port 17a may be a simple mechanism such as a hole through which print fluid may be added. It is to be appreciated that in examples where the main tank 15a is vented to atmosphere, the exchange port 30a is to be sealed to avoid print fluid from flooding the feeder tank 20a and up the vent port 25a.

In the present example, the refill port 17a provides an airtight seal such that air is exchanged with the print fluid supply. The refill port 17a may include an air vent (not shown) and a fluid passage (not shown). During refilling of the main tank 15a, print fluid from the print fluid supply may flow into the main tank 15a. As the main tank 15a fills with print fluid, air is to be displaced and exits through the air vent into print fluid source. In the present example where the print fluid source is a bottle of print fluid, air from the main tank replaces the print fluid in the bottle. Accordingly, the filling process in the present example is carried out in a closed system. By maintaining the closed system, the amount of liquid entering the main tank 15a will not exceed the amount of volume available in the main tank 15a. Accordingly, this may be to reduce potential wastage of liquid during the filling process.

Furthermore, in the present example, the vent port 25a extends further up from the feeder tank 20a. It is to be appreciated that the exact design of the vent port 25a is not particularly limited. The vent port 25a is to vent the feeder tank 20a to atmospheric pressure. By extending the vent port 25a further from the feeder tank 20a, additional tip-resistant features may be added to reduce the likelihood of print fluid leakage in the event of a tipping of the printing device. For example, various valves and air pathways may be introduced to trap print fluid from escaping the feeder tank 20a.

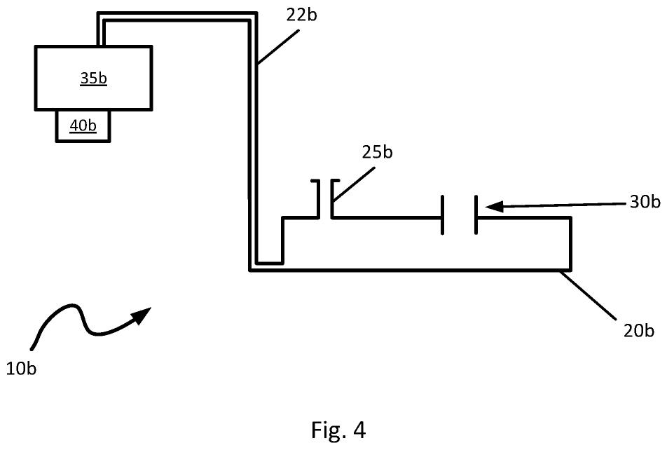

Referring to FIG. 4, another example of an apparatus to dispense print fluid onto media is generally shown at 10b. Like components of the apparatus 10b bear like reference to their counterparts in the apparatus 10, except followed by the suffix “b”. The apparatus 10b may be a part of a printing device or a sub-component of the printing device to deliver print fluid from a tank to the media. The apparatus 10b includes a feeder tank 20b, a vent port 25b, an exchange port 30b, a print head assembly 35b, and a nozzle 40b. The apparatus 10b may include additional components, such as various additional interfaces and/or control systems to operate the print head assembly 35b and the nozzle 40b. It is to be appreciated that the apparatus 10b does not include a main tank.

In the present example, the feeder tank 20b is to receive print fluid via the exchange port 30b from a print fluid source. For example, the exchange port 30b may include a connector such as threading to receive a detachable bottle of print fluid. It is to be appreciated that the connector is not particularly limited and other manners to connect the print fluid source are contemplated, such as a mechanism involving guides, tabs, and/or complementary bosses to provide a friction fit.

Furthermore, the feeder tank 20b is in fluidic communication with the nozzle 40b of the print head assembly 35b. In the present example, the feeder tank 20b includes a fluid line 22b leading to the print head assembly 35b to maintain the fluidic communication. Furthermore, the feeder tank 20b is to be disposed within the printing device below the nozzle 40b at a relatively lower position. It is to be appreciated by a person of skill with the benefit of this description that by positioning the feeder tank 20b below the nozzle 40b and by venting the surface of the print fluid in the feeder tank 20b to atmospheric pressure via the vent port 25b, a natural backpressure is maintained at the nozzle 40b to reduce drool from the nozzle.

The exchange port 30b is generally disposed on the feeder tank 20b to receive a print fluid source, such as a main tank. In the present example, the main tank may be a separate consumable part to be subsequently attached and re-used. The exchange port 30b is to regulate the flow of print fluid such that print fluid does not flow into the feeder tank 20b from the print fluid source unless the level of print fluid within the feeder tank 20b decreases below a threshold amount. In the present example, the threshold amount represents a physical level within the feeder tank 20b, such as a vertical height above the bottom of the feeder tank 20b. Therefore, the feeder tank 20b maintains a volume of air (referred to as the feeder tank air) that is to be equilibrated with atmospheric pressure via the vent port 25b.

In the present example, the print head assembly 35b is to receive print fluid from the feeder tank 20b. It is to be appreciated that the manner by which the print head assembly 35b receives the print fluid from the feeder tanks 20b is not particularly limited. For example, the print head assembly 35b may include a motor and/or vacuum to draw the print fluid via the fluid line 22b. In other examples, the print head assembly 35b may use capillary action to draw the print fluid. In further examples, a pump (not shown) may be added along the fluid line 22b.

In some examples, the print head assembly 35b may also include various control components such as a controller or microprocessor. The controller or microprocessor may receive electrical signals corresponding with a print job. The print head assembly 35b may then coordinate the nozzle 40b to dispense the print fluid onto media to generate a document.

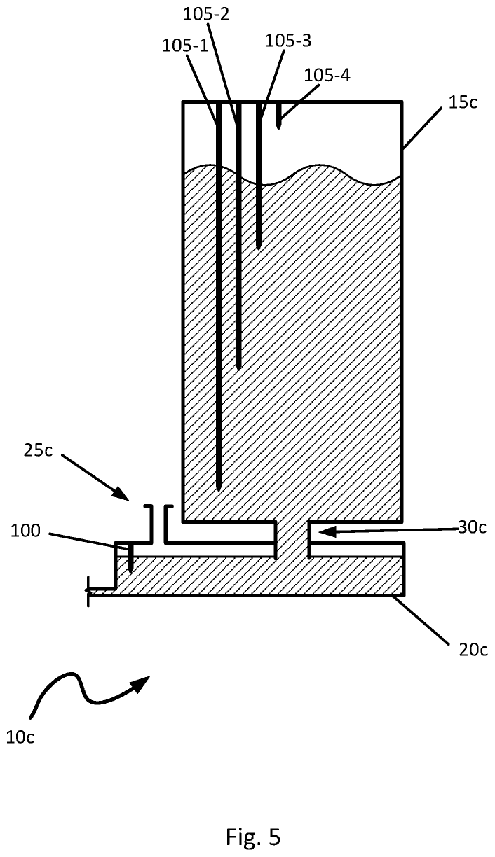

Referring to FIG. 5, another example of an apparatus to dispense print fluid onto media is generally shown at 10c. Like components of the apparatus 10c bear like reference to their counterparts in the apparatus 10, except followed by the suffix “c”. The apparatus 10c may be a part of a printing device or a sub-component of the printing device to deliver print fluid from a tank to the media. The apparatus 10c includes a main tank 15c, a feeder tank 20c, a vent port 25c, and an exchange port 30c.

In the present example, the apparatus 10c may further include a detector 100 disposed in the feeder tank 20c. The detector 100 is to generally measure the level of the print fluid in the feeder tank. For example, the detector 100 may be an electrically conductive sensing rod extending to a fixed location in the feeder tank 20c. It is to be appreciated that the fixed location may be a predetermined level where the apparatus 10c may be considered to be low on print fluid and initiate a warning system to alert a used of the printing device to refill the apparatus 10c. The warning system is not particularly limited and may include audio and visual cues. In addition, in same examples, the warning system may be connected a network where a message may be sent to a user or administrator remotely.

The manner by which the detector measures the level of print fluid in the feeder tank 20c is not limited. In the present example, the detector 100 may be conductive and electrically isolated from the conductive walls of the feeder tank 20c. In this example, a voltage may be applied across the detector 100 and the walls of the feeder tank 20c. As the electrically conductive print fluid contacts the detector 100, the voltage difference may be measured to be substantially zero. However, as the print fluid level decreases in the feeder tank 20c below the tip of the detector 100, the electrical circuit will be broken and the voltage will increase to provide an indication that the print fluid in the feeder tank 20c is low.

It is to be appreciated that the sensing rod of the detector 100 is not particularly limited and may not be shaped as a rod in some examples. In some examples, the sensing rod of the detector 100 may be substituted with a wire, a conductive tube, or any other shape. Furthermore, the sensing rod of the detector 100 is not particularly limited and may be made from any conductive material. In the present example, the sensing rod of the detector 100 is to be in contact with a conductive print fluid for a substantial amount of time. Accordingly, the sensing rod of the detector 100 may be made from a corrosion resistant material. In some examples, the sensing rod of the detector 100 may have a protective coating to protect the conductive portions such that a tip may be exposed through the coating to detect the print fluid. Since many protective coatings are generally not electrically conductive, an opening in the coating may be used to allow the conductive element to maintain electrical contact with the print fluid. In some examples, the coating may also be conductive so that the entire sensing rod may be coated.

In the present example, the apparatus 10c may further include a fluid measurement system disposed in the main tank 15c. The fluid measurement system is to generally determine the level of the print fluid in the main tank 15c. In an example, the fluid measurement system may include a plurality of sensing rods 105-1, 105-2, 105-3, and 105-4 extending to fixed positions in the main tank 15c (generically, these sensing rods are referred to herein as “sensing rod 105” and collectively they are referred to as “sensing rods 105). It is to be appreciated that each of the sensing rods 105 may be similar to the sensing rod of the detector 100. Accordingly, by spacing the sensing rods 105 at different heights, an approximation the print fluid level may be obtained. Furthermore, it is to be appreciated that although four sensing rods are disclosed in the present example, more sensing rods 105 may be used to achieve more accurate estimates of the print level. Alternatively, more sensing rods 105 may be used to reduce manufacturing costs.

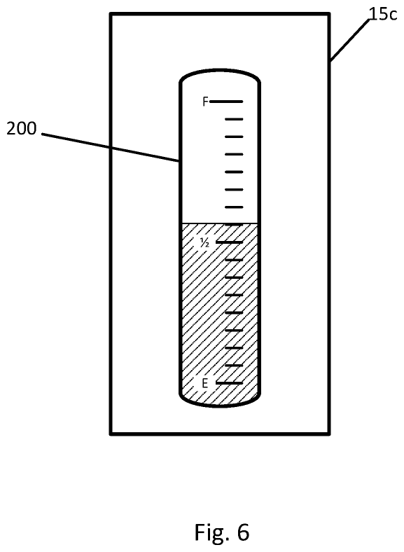

Referring to FIG. 6, another example of a fluid measurement system disposed in the main tank 15c. In this example, the main tank 15c includes a window 200 through which the print fluid level in the main tank 15c may be overserved. It is to be appreciated that in some examples, the feeder tank 20c may not include a detector 100. In such examples, the main tank 15c may be used to measure the print fluid level and provide indicators of low print fluid levels while the feeder tank 20c operates as a reserve tank to provide additional print fluid to the nozzle before completely running out.

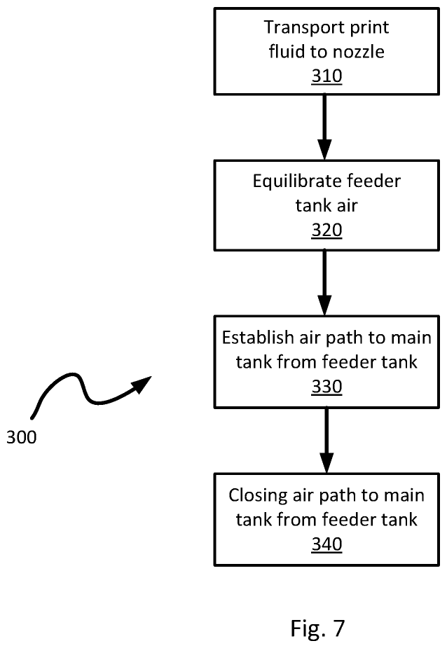

Referring to FIG. 7, a flowchart of a method of delivering print fluid to a print head assembly is generally shown at 300. In order to assist in the explanation of method 300, it will be assumed that method 300 may be performed with the apparatus 10. Indeed, the method 300 may be one way in which apparatus 10 may be configured. Furthermore, the following discussion of method 300 may lead to a further understanding of the apparatus 10 and its various components. Furthermore, it is to be emphasized, that method 300 may not be performed in the exact sequence as shown, and various blocks may be performed in parallel rather than in sequence, or in a different sequence altogether.

Block 310 involves transporting print fluid from the feeder tank 20 to a nozzle. It is to be appreciated that the manner by which the print fluid is transported is not particularly limited. For example, a print head assembly may include a motor and/or vacuum to draw the print fluid via the outlet port 22. In other examples, a pump (not shown) may be added along a fluid line extending from the outlet port 22. The nozzle then dispenses the print fluid onto a media to generate a document. As more print fluid is transported to the nozzle during the generation of documents, it is to be appreciated that the level of the print fluid in feeder tank 20 will decrease.

In block 320, any air in the feeder tank 20 may be constantly vented to the external atmosphere. The feeder tank air may be directly mix with external atmosphere via a vent port 25. Accordingly, the feeder tank air may apply a force on the surface of the print fluid to hold the print fluid in the main tank 15, which is generally at the highest point of the printing device.

Block 330 involves the establishment of an air path to the main tank 15. In the present example, as the level of the print fluid decreases in the feeder tank 20, an exchange port 30 may become exposed. Upon exposing the bottom of the exchange port 30, the feeder tank air will have access to the exchange port 30 and entire the main tank 15. Due to the weight of the print fluid in main tank 15, the print fluid may fall and the feeder tank air may enter the main tank 15 via the exchange port 30.

Block 340 involves the closing the air path to the main tank 15. In the present example, as the level of the print fluid increases in the feeder tank 20 from block 330 where the exchange port 30 is exposed. Upon submerging the bottom of the exchange port 30, the feeder tank air will cease to have access to the exchange port 30 and thus the air path established by Block 330 will be sealed.

It should be recognized that features and aspects of the various examples provided above may be combined into further examples that also fall within the scope of the present disclosure.

What is claimed is:

1. An apparatus comprising:
a main tank disposed above a nozzle, wherein the main tank is to store a bulk amount of print fluid;
a feeder tank in fluidic communication with the main tank and the nozzle, the feeder tank disposed below the nozzle to maintain a backpressure;
a vent port disposed on the feeder tank; and
an exchange port to connect the main tank to the feeder tank, wherein the exchange port allows print fluid to flow from the main tank to the feeder tank in response to a decrease in an amount of print fluid in the feeder tank relative to a threshold amount.

2. The apparatus of claim 1, further comprising a detector disposed in the feeder tank, wherein the detector is to measure a level of print fluid in the feeder tank.

3. The apparatus of claim 2, wherein the detector is a sensing rod extending into the feeder tank to maintain electrical contact with the print fluid above a predetermined level.

4. The apparatus of claim 1, further comprising a fluid measurement system disposed in the main tank.

5. The apparatus of claim 4, wherein the fluid measurement system includes a window through which a level of print fluid in the main tank is measured.

6. The apparatus of claim 4, wherein the fluid measurement system includes a first sensing rod to extend into the main tank to maintain electrical contact with the print fluid above a first predetermined level.

7. The apparatus of claim 6, wherein the fluid measurement system includes a second sensing rod to extend into the main tank to maintain electrical contact with the print fluid above a second predetermined level.

8. The apparatus of claim 1, further comprising a refill port disposed on the main tank to add print fluid to the main tank.

9. An apparatus comprising:
a print head assembly to draw print fluid;
a nozzle disposed on the print head assembly, wherein the nozzle is to dispense the print fluid onto a media;
a feeder tank in fluidic communication with the print head assembly, the feeder tank to provide print fluid to the nozzle, wherein the feeder tank is disposed below the nozzle to maintain a backpressure;
a vent port disposed on the feeder tank to vent to atmosphere; and
an exchange port disposed on the feeder tank, wherein the exchange port is to receive a main tank and to regulate print fluid flow from the main tank to the feeder tank.

10. The apparatus of claim 9, further comprising a detector disposed in the feeder tank, wherein the detector is to measure a level of print fluid in the feeder tank.

11. The apparatus of claim 10, wherein the detector is a sensing rod to extend into the feeder tank to maintain electrical contact with the print fluid above a predetermined level.

12. The apparatus of claim 9, wherein the vent port includes a tip-resistant opening.

13. A method comprising:
transporting print fluid from a feeder tank to a nozzle, wherein the nozzle dispenses the print fluid onto a media, and wherein a level of the print fluid decreases as the print fluid is transported from the feeder tank;
equilibrating feeder tank air to atmosphere to maintain a surface pressure on the print fluid in the feeder tank with a vent;
establishing an air path to a main tank as the level of the print fluid decreases below an exchange port in the feeder tank; and
closing the air path between the main tank and the feeder tank as the level of the print fluid increases above the exchange port in the feeder tank.

14. The method of claim 13, further comprising detecting the level of the print fluid in the feeder tank.

15. The method of claim 13, further comprising detecting the level of the print fluid in the main tank.
